(19) United States
(12) Patent Application Publication
(10) Pub. No.: US 2025/0005924 A1
(43) Pub. Date: Jan. 2, 2025

(54) Visual Transformers with Sparse Application of Video Kernels

(71) Applicant: Google LLC, Mountain View, CA (US)

(72) Inventors: Anthony J. Piergiovanni, Denver, CO (US); Wei-Cheng Kuo, Santa Clara, CA (US); Anelia Angelova, Palo Alto, CA (US)

(21) Appl. No.: 18/577,051

(22) PCT Filed: Nov. 22, 2023
(86) PCT No.: PCT/US2023/080947

§ 371 Date: Jan. 5, 2024

Related U.S. Application Data
(60) Provisional application No. 63/427,238, filed on Nov. 22, 2022.

(51) Int. Cl. G06V 20/40; G06V 10/776; G06V 10/82

(52) U.S. Cl. CPC G06V 20/41; G06V 10/776; G06V 10/82; G06V 20/46

(57) ABSTRACT

Provided are machine-learned models for performing video processing with improved efficiency. In particular, the machine-learned model can perform the sparse application of one or more video kernels to a set of video data to generate video tokens that can, for example, be provided as input to a visual transformer. Thus, example implementations of the present disclosure are directed to an approach which can turn a visual transformer (e.g., a ViT encoder) into an efficient video model. Furthermore, example implementations described herein can seamlessly work with both image and video inputs. Specifically, by sparsely sampling the inputs, the model is able to do training and inference from both inputs. The proposed model is easily scalable and can optionally be adapted to large-scale pre-trained visual transformers without requiring full finetuning.

### RELATED APPLICATIONS

This application claims priority to and the benefit of U.S. Provisional Patent Application No. 63/427,238, filed Nov. 22, 2022. U.S. Provisional Patent Application No. 63/427,238 is hereby incorporated by reference in its entirety.

### FIELD

The present disclosure relates generally to machine learning. More particularly, the present disclosure relates to the use of visual transformers in combination with sparse application of video kernels for joint image and video learning.

### BACKGROUND

Transformer models are a type of machine learning model that leverages a self-attention mechanism over a sequence of tokens or embeddings at each of a number of layers. One example “vanilla” transformer architecture is described in Vaswani et al., Attention is all you need. In NeurIPS, 2017.

Although transformer models were originally applied to natural language settings, they have since been adapted for and widely applied to single image vision tasks such as image classification. Transformers applied to vision tasks can be referred to as visual transformers or vision transformers. One example transformer model configured to process single images is the ViT model described in Dosovitskiy et al., An image is worth 16×16 words: Transformers for image recognition at scale. In ICLR, 2021. As applied to vision tasks, transformers have become an ubiquitous backbone for visual representation learning, leading to many advances in image understanding, multimodal tasks, and self-supervised learning, etc.

Video understanding is an essential computer vision task. However, adaptations of transformer models to video are both challenging and computationally intensive. Therefore, video versions of transformer models have been specially designed to handle the larger number of frames.

In particular, due to the quadratic cost of self-attention and the dense sampling, the use of transformers for videos has required different elements, such as space-time factorized attention. However, these video transformers have not truly been tested on longer videos as most are evaluated on short clips. The ability to handle larger numbers of input frames and understand long-term actions and their relationships is of key importance, but becomes computationally prohibitive with current models.

Other works have studied ways to reduce the number of tokens in video transformer models. However, all these works still use an initial dense sampling of the video, then some heuristics to reduce the number of inputs. Thus, transformer model architectures which enable processing video with improved efficiency are desired in the art.

Furthermore, most previous works treat image and video as entirely different inputs, providing independent methods for either videos or images, since designing a model capable of handling both is challenging. For example, certain previous methods for co-training image and video adapt the architectures to do so with significant portions of the network separately designed for each input. As another example, certain works resample the input and compress it into a fixed number of features. However, this resampling can still be expensive for long videos, and certain approaches in this vein treat videos as individual frames sampled at 1 FPS, which limits the temporal information. Such low FPS sampling and per-frame modeling is often insufficient for datasets which rely on motion and temporal understanding or for recognizing quick and short actions. On the other hand, using one of the above-mentioned approaches with dense frames is computationally infeasible.

### SUMMARY

Aspects and advantages of embodiments of the present disclosure will be set forth in part in the following description, or can be learned from the description, or can be learned through practice of the embodiments.

One example aspect of the present disclosure is directed to a computer system for performing video processing tasks with improved computational efficiency, the computer system comprising: one or more processor and one or more non-transitory computer-readable media. The one or more non-transitory computer-readable media collectively store a machine-learned model comprising: a video kernel configured to be applied to a plurality of data samples from a set of video data to respectively generate a plurality of video tokens, wherein each data sample comprises at least a portion of multiple image frames included in the set of video data; and a visual transformer configured to process the plurality of video tokens to generate a model output. The one or more non-transitory computer-readable media collectively store instructions that, when executed by the one or more processors, cause the computer system to perform operations. The operations include: processing the set of video data with the machine-learned model to generate the model output; wherein processing the set of video data with the machine-learned model comprises sparsely applying the video kernel to the set of video data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of example machine learning models according to example embodiments of the present disclosure.

FIG. 2 depicts a graphical diagram of example machine learning models according to example embodiments of the present disclosure.

FIG. 3 depicts a graphical diagram of example machine learning models according to example embodiments of the present disclosure.

FIGS. 4A-C depict block diagrams of example computing systems and devices according to example embodiments of the present disclosure.

Reference numerals that are repeated across plural figures are intended to identify the same features in various implementations.

### DETAILED DESCRIPTION

### Overview

Generally, the present disclosure is directed to machine-learned models for performing video processing with improved efficiency. In particular, the machine-learned model can perform the sparse application of one or more video kernels to a set of video data to generate video tokens that can, for example, be provided as input to a visual transformer. Thus, example implementations of the present disclosure are directed to an approach which can turn a visual transformer (e.g., a ViT encoder) into an efficient video model. Furthermore, example implementations described herein can seamlessly work with both image and video inputs. Specifically, by sparsely sampling the inputs, the model is able to do training and inference from both inputs. The proposed model is easily scalable and can optionally be adapted to large-scale pre-trained visual transformers without requiring full finetuning.

More particularly, to address computational challenges associated with various existing approaches, the present disclosure proposes an effective model, example implementations of which can be referred to as “TubeViT”. The proposed model can utilize existing visual transformer architectures (e.g., a standard ViT model) seamlessly for both image and videos. Specifically, the proposed models can implement Sparse Video Tubes, which are a lightweight approach for video learning (e.g., joint image and video learning). Example implementations of the proposed techniques work by sparsely sampling one or more variously-sized 3D space-time tubes from the video to generate learnable tokens, which are used by the visual transformer.

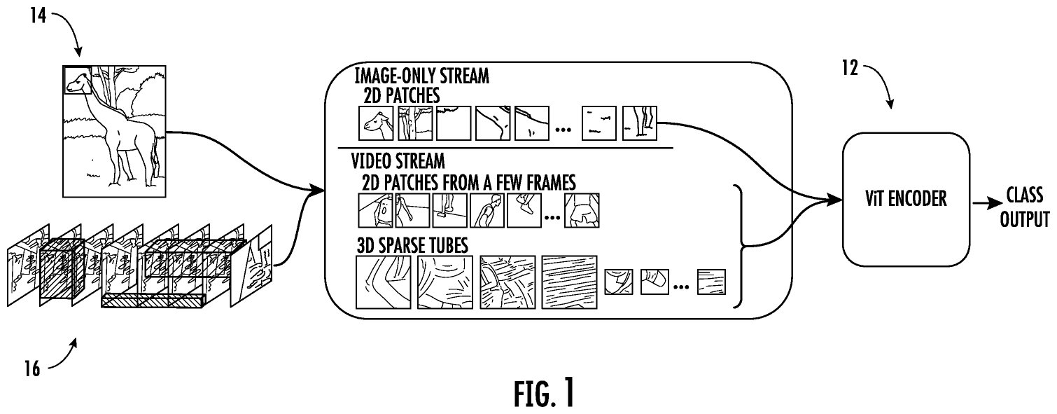

With sparse video tubes, the model is easily applicable to either image and/or video input, and can better leverage either or both sources of data for training and fine-tuning. The sparse video tubes naturally handle raw video signals and/or image signals, which is helpful for understanding actions and other spatio-temporal information in videos. As an example, FIG. 1 shows an example model according to aspects of the present disclosure. Specifically, with Sparse Video Tubes, a visual transformer 12 can be used to process image inputs 14, video inputs 16, and/or both inputs 14 and 16, thereby providing an efficient video backbone and more accurate performance. Furthermore, due to the flexibility of the transformer model in accepting tokens of various types and/or lengths, the input to the transformer can also include tokens generated from other modalities of data beyond the image and/or video tokens. For example, speech tokens, natural language tokens, and/or other tokens can be provided as input for other forms of multi-modal processing tasks.

By using the sparse video tubes, example implementations of the present disclosure are able to better share the weights learned for both images and videos. This is in contrast to prior works that either inflate kernels or add new temporal-specific layers. Further, due to the sparse sampling, the number of tokens remains low, which is also beneficial for both for reducing computational expenditure (e.g., in terms of FLOPs) and improving performance. Technical effects and benefits of the present disclosure therefore include both reduced consumption of computational resources and improved performance or functionality of computer systems with respect to various computer vision tasks. For example, video-based computer vision tasks can include video classification, video recognition, object detection or classification in videos, embedding generation (e.g., for video representation), and/or other video processing or vision tasks.

Thus, the present disclosure provides sparse video tubes, which can be obtained by sparsely sampling videos with various sized 3D space-time tubes or video kernels. Using these sparse video kernels, example implementations of the present disclosure can accomplish some or all of the following: (1) a universal visual backbone which easily adapts a visual transformer (e.g., ViT) to videos; (2) joint image and video understanding which seamlessly uses either input; and/or (3) an easy-to-scale approach for video understanding, which can also leverage already trained (large) visual transformer models.

Furthermore, in contrast to previous works, the proposed techniques enable computationally efficient application of a single transformer model to a large set of video data. Example differences that enable this computational efficiency include: that the tubes are sparsely applied to the raw input, that the model consists of different shaped, possibly overlapping tubes, and that the model uses a single, shared backbone network. This leads to both more efficient and accurate models. Furthermore, the model can be entirely shared between the image and video modalities. This is a valuable distinction as it not only improves performance for both tasks, but is also more generally applicable to vision tasks.

Another aspect of the present disclosure is directed to a technique for efficiently scaling from a small video model to a large video model using a pre-trained image model. Specifically, video models are typically computationally expensive to train, and previous works have studied ways to leverage already trained models, such as using frozen ones or adapting them to videos. Example implementations of the present disclosure expand on these ideas, and use the Sparse Video Tubes to adapt much larger pre-trained visual transformer models to videos with lightweight training. Thus, powerful large video models can be created while consuming fewer computational resources such as processor usage, memory usage, network bandwidth, etc.

With reference now to the Figures, example embodiments of the present disclosure will be discussed in further detail.

### Example Models and Techniques

### Example Dense Sampling Approaches

A standard ViT architecture takes an image and converts it into patch embedding, for example, by using a 16×16 2D convolutional kernel, with a 16×16 stride. This results in a sequence of patches as the image representation, e.g., 196 for a 224×224 input image.

Given a video V∈ [symbol] ^{T×H×W×C}, prior applications of visual transformers either used the same, dense 2D patches independently for all frames (e.g., densely applied 2D patches on a per-frame basis) or used completely dense 3D kernels (e.g., densely applied 3D patches to multiple frames with a temporal stride of one). As one example, ViVit (Arnab et al., Vivit: A video vision transformer. In ICCV, 2021) densely applied 2×16×16 or 4×16×16 to all frames in the video. In both cases (dense application of 2D kernels or dense application of 3D kernels), this results in significantly more tokens, e.g., T*196, where T is the number of frames.

In prior approaches, these tubes or patches are then linearly projected into an embedding space, zᵢ∈ [symbol] ^{d}. This sequence of tokens is then processed by a transformer encoder, using standard components, e.g., MSA—the multi-head self-attention and MLP—the standard transformer projection layer. For example, for a sequence of layers l∈[0,1, . . . L], a transformer can compute the representation y and next token features z for all the zᵢ^{l} tokens (LN denotes Layer Norm):

$${y}_{i}^{l} = MSA ( L N ( {z}_{i}^{l - 1} ) ) + {z}_{i}^{l - 1} \qquad ( 1 )$$

$${z}_{i}^{l} = MLP ( L N ( {y}_{i}^{l} ) ) + {y}_{i}^{l} \qquad ( 2 )$$

To reduce the computational cost, a system can factorize the attention mechanism, to have a spatial and temporal attention or use multiple views with smaller, view level transformers. However, factorization of the attention mechanism does not directly resolve challenges associated with the number of tokens.

### Example Sparse Video Tubes

In contrast to the dense sampling techniques described above, example implementations of the present disclosure implement a simple and straightforward method which is seamlessly applicable to both images and videos. For example, some example implementations can of the present disclosure can follows the standard ViT tokenization approach for images: a 2D convolution with a 16×16 kernel. However, example implementations build on the observation that sparseness is effective for videos. Therefore, rather than following the prior works that densely tokenize the video, some example implementations instead use the same 2D kernel, but with a large temporal stride, for example, applied to every 16th frame. Thus for an input video clip of 32×224×224, this results in only 392 tokens, rather than the 6 k in TimeSFormer or 1-2 k in ViViT.

However, this sparse spatial sampling might lose information, especially for quick or short actions. Thus, some example implementations can create sparse video tubes of different shapes (e.g., various 3D shapes). Specifically, video kernels having these shapes can be applied to video data sampled according to these shapes to generate video tokens. Kernels can also be referred to as filters.

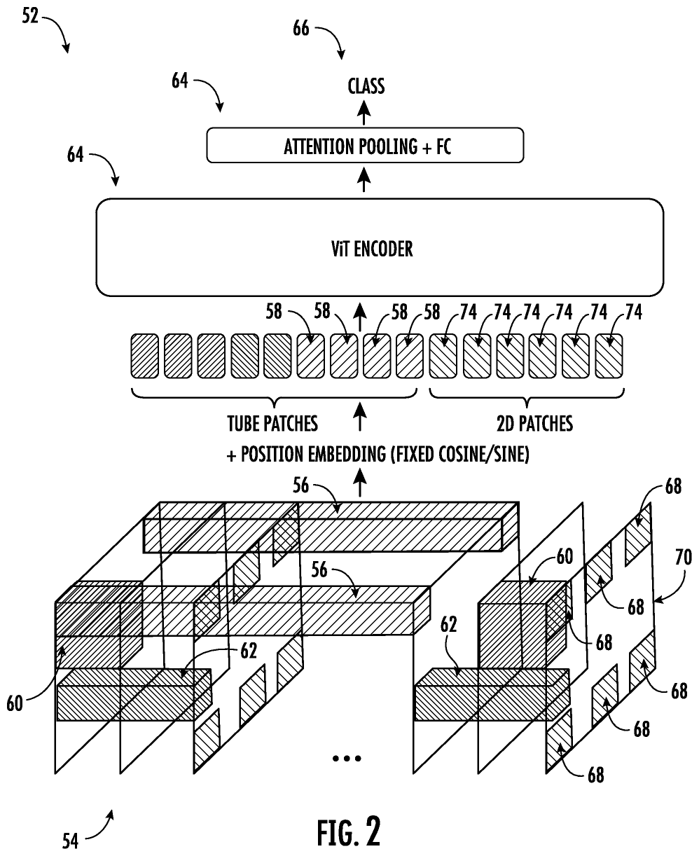

3D shapes can generally refer to shapes having a temporal length (e.g., length in terms of number of frames), a spatial height, and a spatial width. These shapes can also be thought of as 4D shapes when a channel depth of the data is considered. Some example implementations can also optionally add an offset to the start location, so that the patches do not always start at (0,0,0) and this allows a reduction in the overlap between the tubes. This is illustrated in FIG. 2.

Specifically, we can represent a tube as (T×H×W) for the kernel shape, (Tₛ, Hₛ, Wₛ) for the spatio-temporal stride applied to the kernel, and (x,y,z) as the offset of the starting point of the convolution. As one example, a 16 frame×4 pixel×4 pixel tube can be used to obtain information from many frames at low spatial resolution. However, the tubes can have any shape. Importantly, in some implementations, the tubes also have large strides, sparsely sampling the video in different views.

Tubes of various sizes are also used in the MultiView approach for video classification (Yan et al., Multiview transformers for video recognition. In CVPR, 2022.). However, in MultiView the 3D tubes are densely sampled and respectively processed by multiple different view-specific transformers, resulting in a more computationally intensive approach. Furthermore, in contrast to prior works, some example implementations of the present disclosure also allow for overlap between the tubes.

With the proposed design, example implementations of the present disclosure enable seamless fusion of the image- and video-visual information. The sparse spatial sampling allows sharing the image and frame tokens and the sparse video tubes create a low number of video-specific tokens. This enables better sharing of the visual transformer model between images and videos.

As one example, FIG. 2 illustrates an example application of the model 52 to a set of video data 54. Specifically, the example machine-learned model 52 can include a video kernel 56 configured to be applied to a plurality of data samples from the set of video data 54 to respectively generate a plurality of video tokens 58. Each data sample can include at least a portion of multiple image frames included in the set of video data 54. Although kernel 56 is called out with reference to FIG. 2, additional example video kernels 60 and 62 are illustrated, which can also be sparsely applied to generate additional video tokens.

The model 52 can also include a visual transformer 64 configured to process the plurality of video tokens 58 (and any other tokens present) to generate a model output 66.

Thus, the machine-learned model 52 can process the set of video data 54 to generate the model output 66. Specifically, processing the set of video data 54 with the machine-learned model 52 can include sparsely applying the video kernel 56 to the set of video data.

In some implementations, the video kernel 56 has a spatial dimension size and sparsely applying the video kernel 56 to the set of video data 54 can include applying the video kernel 56 with a spatial stride greater than the spatial dimension size of the video kernel 56 to achieve spatial sparseness.

In some implementations, the video kernel 56 has a temporal dimension size and sparsely applying the video kernel 56 to the set of video data 54 can include applying the video kernel 56 with a temporal stride greater than the temporal dimension size of the video kernel 56 to achieve temporal sparseness.

In some implementations, the video kernel 56 can be directly applied to the set of video data 54 (e.g., as opposed to linearly projecting or transforming the video data 54 first. For example, the video kernel 56 can be directly applied to pixel values included in the set of video data 54.

Furthermore, in some implementations, the machine-learned model 52 can further include one or more image kernels (e.g., image kernel 68) configured to be applied to an individual image frame (e.g., frame 70) of the set of video data to generate a plurality of image tokens (e.g., tokens 74) from the individual image frame.

In some implementations, the machine-learned model 52 can include a single visual transformer (e.g., the transformer 64) configured to jointly process both the plurality of video tokens (e.g., video tokens 58) and the plurality of image tokens (e.g., image tokens 74) to generate the model output 66. For example, this is in contrast to certain multi-view approaches that use a separate transformer for each “view” taken from a video. These multiple transformer approaches are required due to the density of sampling combined with the quadratic cost of the attention mechanism. By processing all tokens using a single transformer, the resulting quality can be improved as cross-attention is able to be performed across all available tokens.

In some implementations, sparsely applying a video kernel to the set of video data 54 can include applying the video kernel starting at a predefined offset point that differs from an origin point of the set of video data 54. For example, video kernel 62 is applied starting at a spatial location that is not equal to (0,0). In another example, the offset can be a temporal offset such that the first application of the kernel begins at a frame that differs from a first frame of the video data.

In some implementations, data samples to which different kernels are applied can be overlapping. For example, in FIG. 2, video kernel 56 and video kernel 60 are applied to overlapping samples in the frames shown on the left-hand side of video data 54.

As one example, the model output 66 can be or include a video classification output. However, other forms of outputs for other video understanding or computer vision tasks can be output as well, including, as examples, video recognition, object recognition, object detection, image classification, image recognition, video representation, image representation, and/or others.

### Example Positional Embeddings for Sparse Video Tubes

Another example aspect of the proposed approach is the implementation of the positional embedding. In language models, relative positional embeddings are a common and effective approach. However, here, the relative position between two tokens has minimal meaning, and no real reference to where the patch/tube came from in the original video or image.

Certain existing vision models use learnable positional embeddings for the patches. Here, such an approach can be hard for the model, as these learned embeddings do not necessarily reflect where the patches came from in the original video, especially in the case where patches overlap.

Instead, some example implementations of the present disclosure can use a fixed sine/cosine embedding. The stride, kernel shape and offsets of each tube can be taken into account when applying the positional embeddings. This ensures that the positional embedding of each patch and tube has the global spatio-temporal location of that tube.

As one example, the embeddings can be computed as follows. Here r is a constant hyperparameter (e.g., 10,000). For j from 0 to d//6 (d is the number of features), and for t,x,y from 0 to T, H, W, zᵢ∈ [symbol] ^{T×H×W×D}:

$${ω}_{j} = \frac{1}{{τ}^{j}} \qquad ( 3 )$$

$${p}_{j , t} = sin ( t * {ω}_{j} ) , cos ( t * {ω}_{j} ) \qquad ( 4 )$$

$${p}_{j , x} = sin ( x * {ω}_{j} ) , cos ( x * {ω}_{j} ) \qquad ( 5 )$$

$${p}_{j , y} = sin ( y * {ω}_{j} ) , cos ( y * {ω}_{j} ) \qquad ( 6 )$$

$${z}_{i} [ t , x , y , 6 j : 6 ( j + 1 ) ] + = [ {p}_{j , t} , {p}_{j , x} {p}_{j , y} ] \qquad ( 7 )$$

This adds each spatio-temporal position embedding to the feature dimension of the token zᵢ. This can be done for different wavelengths for each channel. d//6 can be used when there are 6 elements (a sine and cosine value for each x, y, t), this creates a position value for each channel of the representation.

Importantly, here zᵢ [t, x, y] represents the center of the tube, taking into account any strides and offsets used in the tube construction (the channel dimension is not shown here).

After the tokenization step, some example implementations can concatenate all the tokens together and apply a standard transformer model. This simple structure lets the model share the majority of the weights between all inputs, which is quite beneficial.

### Example Sparse Tube Construction

Any number of methods or shapes can be used to create any number of visual tubes. One example approach can include 2 tubes: the 1×16×16×d tube used to tokenize the image and a 8×8×8×d tube additionally used for the video, where d represents the channel depth. Both tubes can have strides of 16×16×16. This base tokenizer provides strong performance, any number of variations from this example are possible.

Multi-Tube. Some example implementations add multiple tubes of various sizes to the core approach. For example, some example implementations can include temporally long and spatially small tubes, such as 16×4×4 to learn long actions, or more spatially focused tubes such as a 2×16×16 tube. There are many variations of tube shape and stride which are possible.

Space-to-Depth. Another extension of the core approach is to reduce the number of channels in a tube, e.g., by a factor of 2. Thus the tube shape becomes T×H×W×d/2. Next, the model can concatenate 2 tokens along the channel axis. The stride of the tube (e.g., the temporal stride) can also optionally be reduced. This results in the same number of tokens and dimensions as the original, but effectively increases the kernel size without changing the number of parameters. Stated differently, when the stride is reduced on the time axis, the token now represents T*2×H×W locations, but only uses T*H*W parameters. Although a factor of 2 is given as an example, any factor can be used that comports with the number of channels available.

Interpolated Kernels. In some implementations, rather than having a unique kernel for each tube, the model can learn one 3D kernel of a certain shape (e.g., 8×8×8). Tri-linear interpolation can then be performed to reshape the kernel any number of various different sizes, e.g., 4×16×16 or 32×4×4, etc. depending on the tube configuration. Any sized kernel can be created from this single kernel. This method has several advantages. (1) It reduces the number of learned parameters that are only used on the video stream. (2) It enables more flexible usage of the kernels, e.g., it can be made longer to handle longer videos, or spatially larger to find small objects.

### Example Image and Video Joint Training

As described above, the proposed approach can seamlessly adapt to either image, video, or both inputs. While image+video joint inputs are rare, the ability to use them together while training is beneficial given that many datasets with valuable annotations (e.g., ImageNet, Kinetics) come from either image sources or video sources but not both.

Jointly training with the proposed approach is easy—the image is tokenized by the 2D kernel and the video is tokenized by both the 2D patches (e.g., with large temporal stride) and Sparse Tubes. Both are then passed into a standard ViT; the position embedding can be supplied in either case. The position embedding approach is helpful for the joint training to be effective.

### Example Image-To-Video Scaling Up of Models

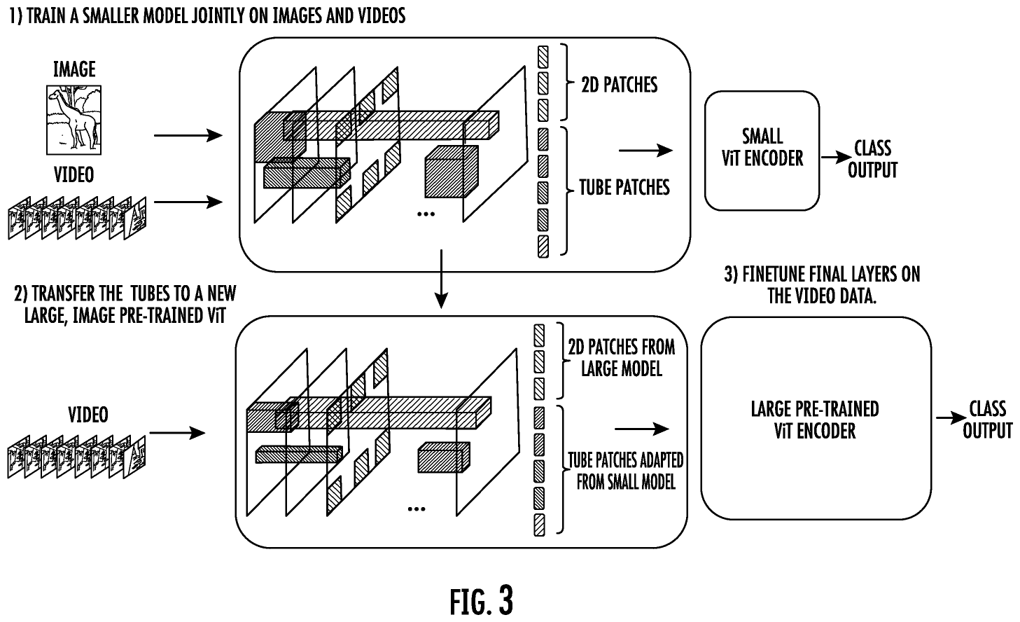

Some example implementations also leverage a more efficient way of scaling up the models (e.g., with an example illustrated in FIG. 3). Training large visual transformer models is computationally expensive, especially for videos. Since nearly all the components of the proposed model are shared between the both images and videos, one example method is to utilize large models without having heavy fine-tuning.

First, a smaller model can be trained jointly on images and videos. This gives a set of weights for the tubes (e.g., the values for the parameters of the video kernels) which are used to generate the video tokens. Then, a large pre-trained image ViT can be modified by further adding the learned tubes. These tubes can use the same kernel weights as the smaller model, and so some example implementations can avoid further training them (though alternatively they may optionally continue to be refined/learned if desired). Since larger ViTs generally use more channel dimensions than smaller ones, the space-to-depth transform can be optionally used again here to create tokens with the proper channel dimensions without needing new weights.

Next, the scaling approach can include picking a point in the network and freeze all the layers before it, for example, the 26th of 32 layers in ViT-H (though alternatively the entire model can continue to be refined/learned if desired) At this point, some example implementations can add a gated connection to the network:

$${z}^{s} = M L P ( L N ( {y}^{s} ) ) + {y}^{s} + tanh ( α ) {z}^{0} \qquad ( 8 )$$

where s is the layer the network is frozen at (e.g., 26) of the ViT model and z⁰ is the raw input tokens from the tubes. α is the learned gating parameter, initialized at 0 (e.g., and which is updated to a non-zero value as training progresses).

In the first steps of training, this gate has no effect on the representation, and thus the ViT is unchanged. However, it can learn to incorporate the raw tubes at this point and further refine the later weights.

Thus, FIG. 3 shows an example approach for scaling of TubeViT models. Given that building large scale video models is expensive, the proposed scaling approach can expand model capacity for video models leveraging large pre-trained ViTs. TubeViT can easily train a small-scale model on both image and video data. Then, the sparse video tubes can be imported to a much larger image-only trained ViT, which can be mostly frozen and/or fine-tuned in part.

### Example Devices and Systems

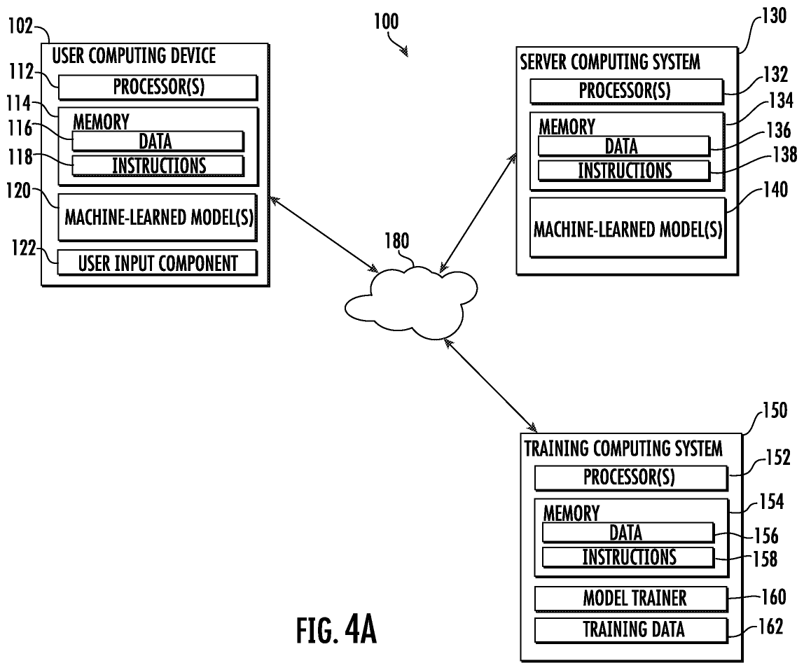

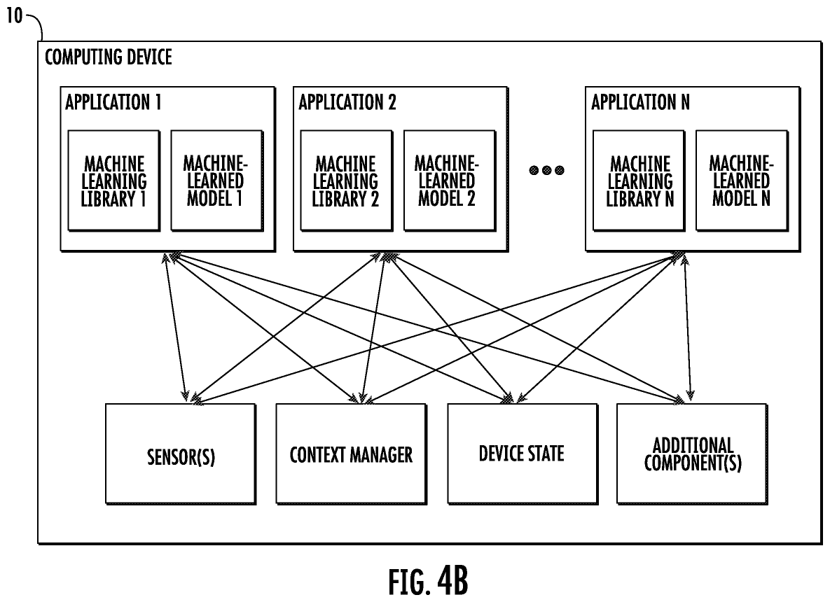

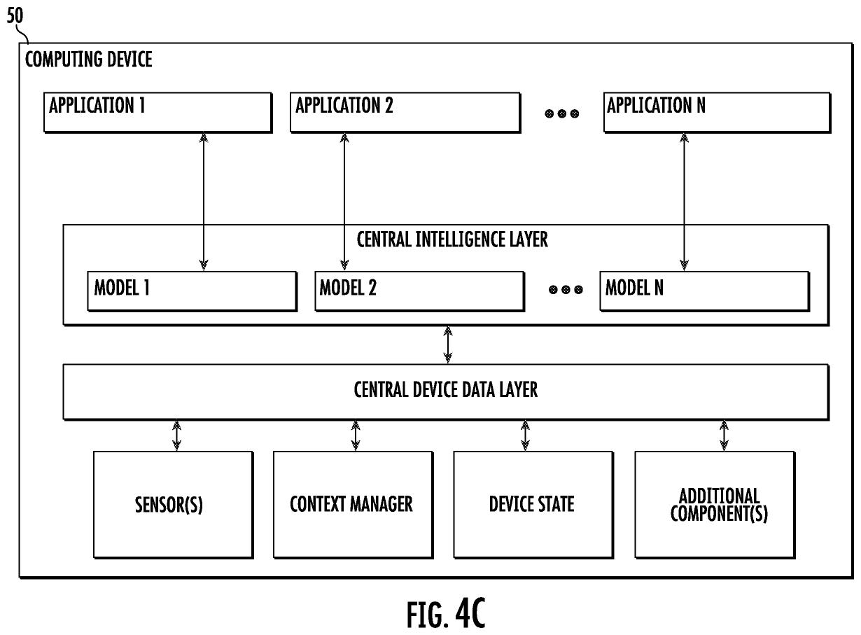

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, video data with an associated label, image data with an associated label, and/or other forms of training data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer system for performing video processing tasks with improved computational efficiency, the computer system comprising:
one or more processors; and
one or more non-transitory computer-readable media that collectively store:
a machine-learned model comprising:
a video kernel configured to be applied to a plurality of data samples from a set of video data to respectively generate a plurality of video tokens, wherein each data sample comprises at least a portion of multiple image frames included in the set of video data; and
a visual transformer configured to process the plurality of video tokens to generate a model output; and
instructions that, when executed by the one or more processors, cause the computer system to perform operations, the operations comprising:
processing the set of video data with the machine-learned model to generate the model output;
wherein processing the set of video data with the machine-learned model comprises sparsely applying the video kernel to the set of video data.

2. The computer system of claim 1, wherein:
the video kernel has a spatial dimension size; and
sparsely applying the video kernel to the set of video data comprises applying the video kernel with a spatial stride greater than the spatial dimension size of the video kernel to achieve spatial sparseness.

3. The computer system of claim 1, wherein:
the video kernel has a temporal dimension size; and
sparsely applying the video kernel to the set of video data comprises applying the video kernel with a temporal stride greater than the temporal dimension size of the video kernel to achieve temporal sparseness.

4. The computer system of claim 1, wherein sparsely applying the video kernel to the set of video data comprises directly applying the video kernel to pixel values included in the set of video data.

5. The computer system of claim 1, wherein the machine-learned model further comprises one or more image kernels configured to be applied to an individual image frame of the set of video data to generate a plurality of image tokens from the individual image frame.

6. The computer system of claim 5, wherein the machine-learned model comprises a single visual transformer configured to jointly process both the plurality of video tokens and the plurality of image tokens to generate the model output.

7. The computer system of claim 1, wherein sparsely applying the video kernel to the set of video data comprises applying the video kernel starting at a predefined offset point that differs from an origin point of the set of video data.

8. The computer system of claim 1, wherein:
the machine-learned model further comprises at least a second kernel configured to be applied to a second set of data samples from the set of video data; and
wherein at least one of the second set of data samples is overlapping with at least one of the plurality of data samples to which the video kernel is applied.

9. The computer system of claim 1, wherein processing the set of video data with the machine-learned model further comprises generating a plurality of fixed sine/cosine positional embeddings respectively for the plurality of video tokens, wherein the fixed sine/cosine positional embedding for each token indicates a center of the video kernel relative to the set of video data.

10. The computer system of claim 1, wherein each of the plurality of data samples comprises data for only a subset of a number of channels in a channel dimension of the set of video data, and wherein at least one of the plurality of tokens is generated by concatenation along a channel dimension for two temporally-displaced data samples.

11. The computer system of claim 1, wherein the machine-learned model comprises a pre-trained vision encoder that has been fine-tuned using a set of video training data.

12. The computer system of claim 1, wherein the model output comprises a video classification output.

13. A computer-implemented method, the method comprising:
obtaining, by a computing system comprising one or more computing devices, a set of video data and a video label;
processing, by the computing system, the set of video data with a machine-learned model to generate the model output, wherein processing the set of video data with the machine-learned model comprises:
sparsely applying, by the computing system, a video kernel of the machine-learned model to the set of video data to generate a plurality of video tokens, the video kernel having a temporal dimension size of greater than one; and
processing, by the computing system, the plurality of video tokens with a visual transformer of the machine-learned model to generate the model output;
evaluating, by the computing system, a loss function that generates a loss value based on the model output and the video label; and
modifying, by the computing system, one or more values of one or more parameters of the machine-learned model based on the loss function.

14. The computer-implemented method of claim 13, wherein modifying, by the computing system, the one or more values of the one or more parameters of the machine-learned model based on the loss function comprises updating parameter values of the video kernel based on the loss function.

15. The computer-implemented method of claim 13, further comprising:
importing the video kernel to a larger pre-trained image transformer.

16. The computer-implemented method of claim 13, wherein modifying, by the computing system, the one or more values of the one or more parameters of the machine-learned model based on the loss function comprises finetuning one or more layers of a pre-trained image transformer while holding one or more other layers of the pre-trained image transformer fixed.

17. The computer-implemented method of claim 13, wherein the machine-learned model further comprises one or more image kernels configured to be applied to an individual image frame of the set of video data to generate a plurality of image tokens from the individual image frame, and wherein the machine-learned model comprises a single visual transformer configured to jointly process both the plurality of video tokens and the plurality of image tokens to generate the model output.

18. The computer-implemented method of claim 17, wherein the method further comprises:
evaluating, by the computing system, an image loss function that generates an image loss value based on the model output and an image label associated with the individual image frame; and
modifying, by the computing system, one or more values of one or more parameters of the machine-learned model based on the image loss function.

19. One or more non-transitory computer-readable media that collectively store:
a machine-learned model comprising:
a video kernel configured to be applied to a plurality of data samples from a set of video data to respectively generate a plurality of video tokens, wherein each data sample comprises at least a portion of multiple image frames included in the set of video data; and
a visual transformer configured to process the plurality of video tokens to generate a model output; and
instructions that, when executed by the one or more processors, cause the computer system to perform operations, the operations comprising:
processing the set of video data with the machine-learned model to generate the model output;
wherein processing the set of video data with the machine-learned model comprises sparsely applying the video kernel to the set of video data.

20. The one or more non-transitory computer-readable media of claim 19, wherein:
the video kernel has a spatial dimension size and a temporal dimension size; and
sparsely applying the video kernel to the set of video data comprises:
applying the video kernel with a spatial stride greater than the spatial dimension size of the video kernel to achieve spatial sparseness; or
applying the video kernel with a temporal stride greater than the temporal dimension size of the video kernel to achieve temporal sparseness.
